(19) United States
(12) Patent Application Publication
(10) Pub. No.: US 2026/0167187 A1
(43) Pub. Date: Jun. 18, 2026

(54) SYSTEMS AND METHODS FOR COLLECTION AND RETENTION OF VEHICLE EVENT INFORMATION

(71) Applicant: Toyota Jidosha Kabushiki Kaisha, Toyota-shi Aichi-ken (JP)

(72) Inventors: Alexander Granieri, Palo Alto, CA (US); Tristan R. Littlehale, Saratoga, CA (US); Conor Sullivan, Campbell, CA (US); Jimmy Chiu, San Jose, CA (US)

(73) Assignee: Toyota Jidosha Kabushiki Kaisha, Toyota-shi Aichi-ken (JP)

(21) Appl. No.: 18/984,277

(22) Filed: Dec. 17, 2024

(51) Int. Cl. B60W 30/095; G06V 20/56

(52) U.S. Cl. CPC B60W 30/0956; G06V 20/588; B60W 2420/403

(57) ABSTRACT

A system for collecting vehicle event information having one or more vehicle input devices operable to capture environmental data and vehicle steering data. The system includes one or more processors operable to determine a spatial position of the vehicle based on a signal of a GPS unit of the vehicle. The one or more processors are also operable to determine a road condition corresponding to the spatial position of the vehicle; compare the position of the vehicle against the road condition to determine a risk probability corresponding to the spatial position of the vehicle; and adjust a data collection parameter of the at least one of the one or more vehicle input devices according to the risk probability.

### FIELD

The present disclosure generally relates to systems and methods for data collection and retention of vehicle event information.

### BACKGROUND

A vehicle's data capture systems can face challenges due to the volume of data generated by onboard cameras and sensors during the operation of the vehicle. Continuously capturing and processing data using these systems can overwhelm a vehicle's computational resources, while providing limited benefits during standard operation scenarios. Additionally, the aggregation of collected data can lead to the unnecessary processing and storage of inconsequential data. Accordingly, there is a need for a system and method for adaptively adjusting the data collection and retention parameters, which can increase data collection and retention when a vehicle is in proximity to a high-risk area and decrease data collection and retention when a vehicle is unlikely to be involved in an accident.

### BRIEF DESCRIPTION OF THE DRAWINGS

In one embodiment, a system for collecting vehicle event information includes one or more vehicle input devices operable to capture environmental data and vehicle steering data. The system includes one or more processors operable to determine a spatial position of the vehicle based on a signal of a GPS unit of the vehicle; determine a road condition corresponding to the spatial position of the vehicle; compare the position of the vehicle against the road condition to determine a risk probability corresponding to the spatial position of the vehicle; and adjust a data collection parameter of the at least one of the one or more vehicle input devices according to the risk probability.

In another embodiment, a method for collecting vehicle event information includes determining a spatial position of a vehicle using one or more processors based on a signal of a GPS unit of the vehicle; determining a road condition corresponding to the spatial position of the vehicle; determining a risk probability corresponding to a spatial position of the vehicle by comparing the spatial position of the vehicle against the road condition; and adjusting a data collection parameter of one or more vehicle input devices according to the determined risk probability to selectively capture environmental data and vehicle steering data.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

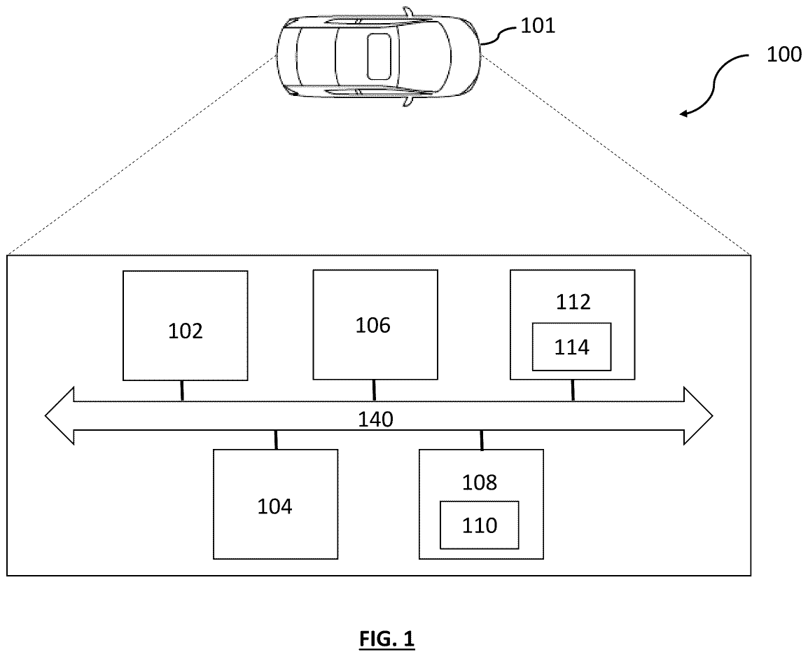

FIG. 1 depicts a schematic diagram of an example system for collecting and retaining vehicle event information, according to one or more embodiments shown and described herein;

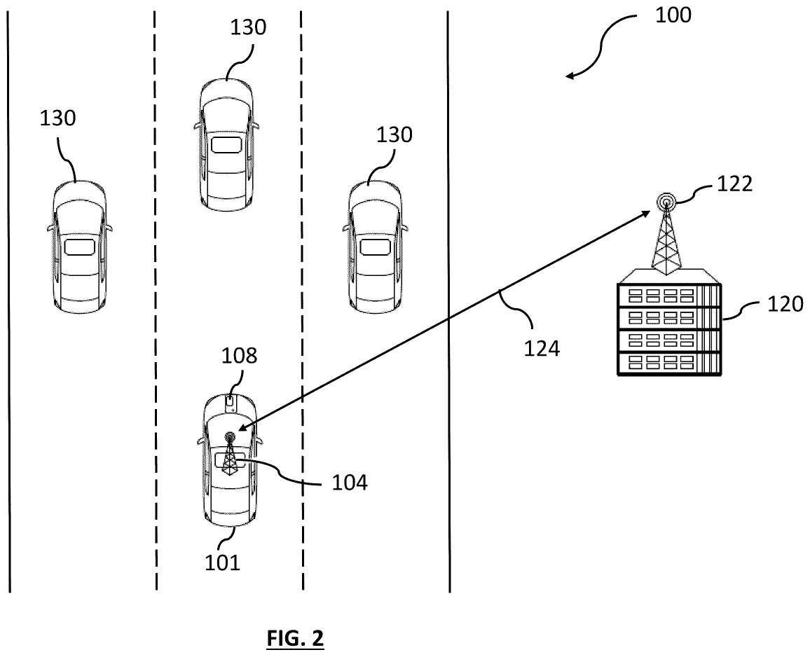

FIG. 2 depicts a schematic diagram of an example system for collecting and retaining vehicle event information in communication with an external server, according to one or more embodiments shown and described herein;

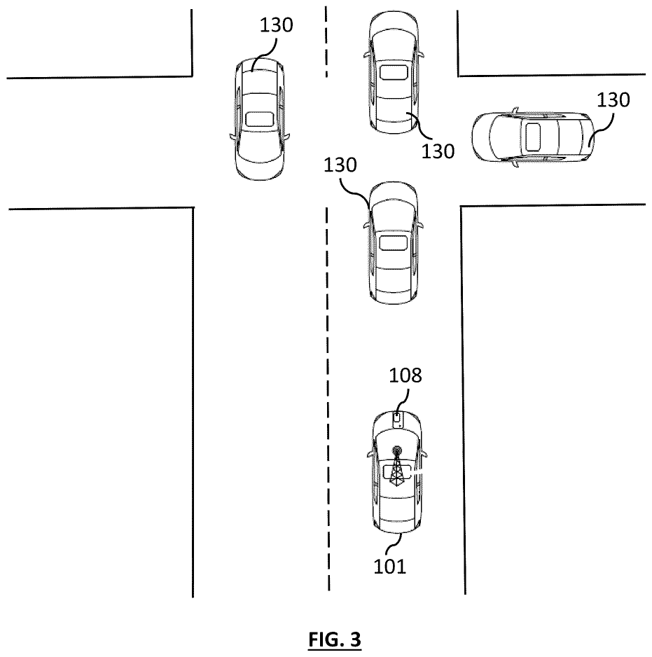

FIG. 3 depicts a schematic diagram of an illustrative example for collecting and retaining vehicle event information, according to one or more embodiments shown and described herein;

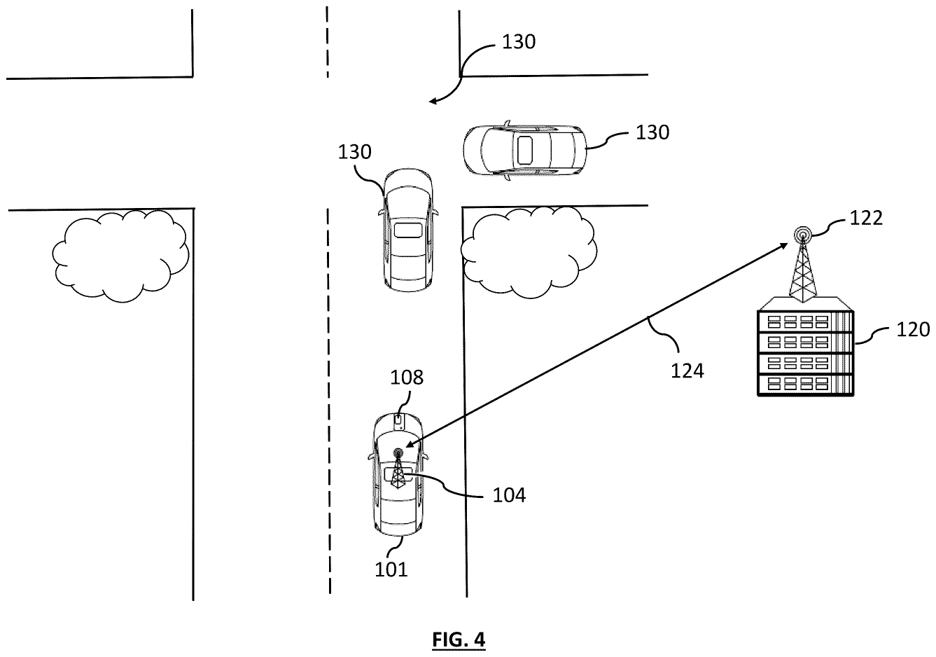

FIG. 4 depicts a schematic diagram of an illustrative example for collecting and retaining vehicle event information, according to one or more embodiments shown and described herein; and

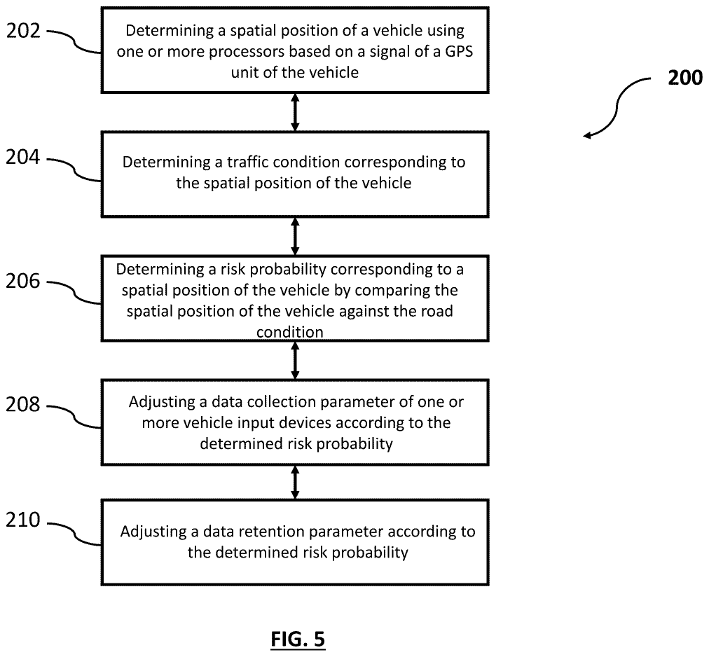

FIG. 5 depicts a flow diagram of an example method to be performed by a processor, according to one or more embodiments shown and described herein.

### DETAILED DESCRIPTION

The present disclosure is directed to systems and methods for adaptively adjusting the collection and retention of data during the operation of a vehicle. Conventional vehicle data collection systems operate by continuously processing image and sensor data to capture and retain vehicle event information for analysis in the event of a vehicle collision. With modern improvements to vehicle data collection systems, vehicles are capable of capturing exceedingly large amounts of data with high resolution. However, the vast majority of this information does not contribute to the operation of the vehicle and is not relevant when the vehicle is not involved in a collision. This excess data can overwhelm a vehicle's computational resources while providing limited benefits. Additionally, the aggregation of excess data can lead to the unnecessary processing and storage of data, requiring manufacturers to provide more costly computing and storage components to handle the increased volume.

Accordingly, there is a need for systems and methods for adaptively adjusting the data collection and retention parameters of a vehicle's data capture system. In particular, the risk of getting into a vehicle accident can be correlated with a vehicle's spatial location. For instance, the location of a vehicle within an area corresponding to heavy traffic, adverse weather conditions, or with a demonstrated history of increased vehicle collision rates can all be used to predict a future collision and adjust data collection and retention rates accordingly. As such, the present disclosure is directed to systems and methods for adjusting the collection and retention of vehicle event information around dangerous roadways and intersections by increasing data collection and retention when a vehicle is in proximity to a high-risk area and decreasing data collection and retention when a vehicle is not in within the proximity of a high-risk area, and thus unlikely to be involved in an accident.

FIGS. 1 and 2 depict schematic diagrams of an exemplary vehicle event information collection system 100. As illustrated in FIG. 1, the system 100 includes a vehicle 101, at least one processor 106, a GPS unit 102, a memory module 112, and one or more vehicle input devices 108. In some embodiments, the system 100 additionally includes one or more communication devices 104 and one or more servers 120 in communication with the processor 106 via the one or more communication devices 104. Although FIG. 1 illustrates single instances of the constituent components of the vehicle event information collection system 100, the vehicle event information collection system 100 may include any number of constituent components.

As depicted in FIG. 1, the system 100 includes a vehicle 101. The vehicle 101 can be a conventional, human-operated vehicle or the vehicle 101 may be an autonomous driving vehicle. In embodiments, the vehicle 101 may be any one of a passenger vehicle, a non-passenger vehicle, a taxi, a bus, a scooter, a motorcycle, a truck, or any other type of motorized or electric vehicle. The vehicle 101 may move or appear on various surfaces, such as, without limitations, roads, highways, streets, expressways, bridges, tunnels, parking lots, garages, off-road trails, railroads, or any surfaces where the vehicles may operate. Additionally, the vehicle 101 includes a GPS unit 102 positioned within the vehicle 101 and configured to be in active communication with the processor 106. The GPS unit 102 may be any conventional GPS unit 102 known to those of ordinary skill that is capable of determining a past, present, and/or future spatial position of the vehicle 101. The GPS unit 102 may receive and communicate relevant positional information related to the vehicle 101 such as latitude and longitude coordinates, standard GPS coordinates, a GPS trace, or a partial GPS trace.

Still referring to FIG. 1, the vehicle event information collection system 100 also includes one or more processors 106 positioned within the vehicle 101 and placed in communication with various components, including the GPS unit 102, the memory module 112, the one or more communication devices 104, and the one or more vehicle input devices 108 via a communication path 140 that provides signal interconnectivity between various components of the system 100. Accordingly, the communication path 140 may communicatively couple any number of processors 106 with one another, and allow the components coupled to the communication path 140 to operate in a distributed computing environment. Specifically, each of the components may operate as a node that may send and/or receive data. As used herein, the term “communicatively coupled” means that coupled components are capable of exchanging data signals with one another such as, for example, electrical signals via a conductive medium, electromagnetic signals via air, optical signals via optical waveguides, and the like.

Accordingly, the communication path 140 may be formed from any medium that is capable of transmitting a signal such as, for example, conductive wires, conductive traces, optical waveguides, or the like. In some embodiments, the communication path 140 may facilitate the transmission of wireless signals, such as WiFi, Bluetooth®, Near Field Communication (NFC), and the like. Moreover, the communication path 140 may be formed from a combination of mediums capable of transmitting signals. Accordingly, the communication path 140 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square-wave, vibration, and the like, capable of traveling through a medium.

The processor 106 may be a controller, an integrated circuit, a microchip, a computer, or any other computing device. The processor 106 may be configured to perform operations, make calculations or execute one or more executable programs stored on the memory module 112. The processor 106 may be any suitable device known to those of ordinary skill in the art such as a processing device, computing device, or combinations thereof, including, for example, a multi-core processor, a microcontroller, a field-programmable gate array (FPGA), or an application-specific integrated circuit (ASIC). The processor 106 may also include further auxiliary processing components configured to receive and execute operations, instructions, or programs. In embodiments, the processor 106 may execute one or more software applications that enable remote communications with one or more components of the vehicle event information collection system 100. In embodiments, the vehicle event information collection system 100 may include hardware components such has as transceiver to place the processor 106 in communication with a remote server 120.

The memory module 112 is communicatively coupled to the communication path 140. The memory module 112 may comprise RAM, ROM, flash memories, hard drives, or any device capable of storing machine-readable and executable instructions such that the machine-readable and executable instructions can be accessed by the one or more processors 106. The machine-readable and executable instructions may comprise one or more logic or algorithms written in any programming language of any generation (e.g., 1GL, 2GL, 3GL, 4GL, or 5GL) such as, for example, machine language that may be directly executed by the processor 106, or assembly language, object-oriented programming (OOP), scripting languages, microcode, etc., that may be compiled or assembled into machine-readable and executable instructions and stored on the memory module 112. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 106 along with the memory module 112 may operate as a controller or an electronic control unit (ECU) for the vehicle 101 or any other components of the system 100. In some embodiments, the memory module 112 may comprise two or more memory devices communicatively coupled along the communication path 140.

Referring collectively to FIGS. 1 and 2, the vehicle event information collection system 100 also includes one or one or more vehicle input devices 108 positioned on or about the vehicle 101 and placed in communication with the processor 106 along the communication path 140. In embodiments, the vehicle input devices 108 may be positioned on the exterior of the vehicle 101 to collect and generate environmental data and/or vehicle steering data corresponding to the surroundings of the vehicle 101. The vehicle steering data may comprise a time gap and/or a distance between the vehicle 101 and other vehicles on the road, the acceleration of the vehicle 101, the velocity of the vehicle 101, the velocity of other vehicles, the spatial position of the other vehicles or obstacles, or a collision state of the vehicle 101. The environmental data and/or vehicle steering data may comprise contextual information, such as weather information, a type of the road on which the vehicle 101 is driving, a surface condition of the road, and a degree of traffic on the road. The environmental data may include weather conditions (e.g., sunny, rain, snow, or fog), road conditions (e.g., dry, wet, or icy road surfaces), traffic density, road infrastructure, obstacles (e.g., pedestrians), lighting conditions, geographical features of the road, and other environmental conditions related to driving.

In embodiments, the vehicle event information collection system 100 may include a plurality of vehicle input devices 108, such as one or more vehicle input devices 108 positioned on each side of the vehicle 101 to enable to the vehicle input devices 108 to capture environmental data or vehicle steering data corresponding to a 360° view of the surroundings of the vehicle 101. In embodiments, at least one of the one or more vehicle input devices 108 includes a camera positioned on the exterior of the vehicle 101 to capture still frame images or video of the surroundings of the vehicle 101 as the data input. The camera may be a conventional camera system typically included on stock vehicles such as a surround view monitor, a blind spot detection camera, or a rear camera. Alternatively, the camera may be a dedicated camera configured to solely operate with the vehicle event information collection system 100. In embodiments, at least one of the one or more vehicle input devices 108 comprises a LIDAR sensor positioned on the exterior of the vehicle 101 to capture laser radar data of the surroundings of the vehicle 101 as the data input. Likewise, the one or more vehicle input devices 108 may be an ultrasonic or radio detection device such as a conventional RADAR device to capture radar data of the surroundings of the vehicle 101 as the data input.

In embodiments, the vehicle event information collection system 100 may include vehicle input devices 108 that correspond to a physical condition of the vehicle 101 as the data input. The vehicle input devices 108 may include a collision detector positioned on a front, rear, left side, or right side of the vehicle 101 to output collision information regarding the collision detection. The collision detector may include one or more of a pressure sensor, a force sensor, a proximity sensor, an Arduino impact sensor, a vibration sensor, or the like. Furthermore, at least one vehicle input device 108 may be configured to solely detect vehicle steering data of the vehicle 101 as the data input. At least one vehicle input device 108 may be a speed sensor coupled with the vehicle's accelerometer, the vehicle's wheels, or any other suitable component to detect and communicate a driving speed of the vehicle 101.

In embodiments, the plurality of vehicle input devices 108 may include a single type or category of vehicle input device 108 discussed above. In other embodiments, the plurality of vehicle input devices 108 may include a combination of the various types of vehicle input devices 108 discussed above. For example, in exemplary systems, the plurality of vehicle input devices 108 may include one or more cameras, one or more LIDAR sensors, one or more collision detectors, and one or more speed sensors, each communicating a respective data input to the processor 106.

Still referring to FIG. 1 and FIG. 2, the vehicle event information collection system 100 can determine a relevant road condition 130 according to the environmental data and/or vehicle steering data communicated to the processor 106 by the one or more vehicle input devices 108. The one or more vehicle input devices 108 may monitor the road condition 130 corresponding to a present condition of the vehicle 101 or an upcoming roadway, intersection, or point of interest near the vehicle 101 to determine a risk probability to the vehicle 101 and direct the one or more vehicle input devices 108 to capture and store additional data corresponding to the road condition 130 and the position of the vehicle 101 determined by the GPS unit 102. In embodiments, the road condition 130 may be collision information corresponding to an upcoming collision from an approaching vehicle or corresponding to a detected collision. In embodiments, the road condition 130 is a level of traffic in front of the vehicle 101. In embodiments, the level of traffic may be determined by calculating a number of vehicles per unit area in the proximity of the vehicle 101. In other embodiments, the level of traffic can be determined based on a detected speed, acceleration, braking frequency, or the like of the vehicle 101 and other surrounding vehicles. In embodiments, the road condition 130 may be road information corresponding to obstacles, road signs, road lines, cross walks or other points of interest like schools, hospitals, or the like. In embodiments, the road condition 130 may further include weather information like the present light conditions or detected rain or snow fall in the proximity of the vehicle 101. In embodiments, the road condition 130 can be determined by the processor 106 based on an aggregation of environmental data and vehicle steering data captured by the one or more vehicle input devices 108. Each relevant road condition 130 is determined by the processor 106 and assigned positional information corresponding to its spatial position. The processor 106 may thereby compare the spatial positon of the vehicle 101, determined by the GPS unit 102, to the calculated spatial position of the road condition 130 to evaluate the risk probability to the vehicle 101.

Still referring to FIGS. 1 and 2, the vehicle 101 may include one or more communication devices 104 operable to wirelessly communicate with one or more external servers 120. The server 120 may include corresponding communication hardware 122 to enable the transmission of a wireless data transfer 124 between the vehicle 101 and the one or more servers 120. In embodiments, the one or more servers 120 may include, without limitation, one or more of cloud servers, smartphones, tablets, telematics servers, fleet management servers, connected car platforms, application servers, Internet of Things (IoTs) servers, or any server with the capability to transmit data with vehicles. The wireless data transfer 124 may include the use of one or more computer networks (e.g., a personal area network, a local area network, or a wide area network), cellular networks, satellite networks and/or a global positioning system and combinations thereof. Accordingly, the vehicles 101 and the servers 120 can wirelessly transfer data via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near-field communication protocols. Suitable cellular networks include, but are not limited to, technologies such as LTE, WiMAX, UMTS, CDMA, and GSM.

Referring to FIG. 2, in embodiments where the vehicle event information collection system 100 comprises the communication device 104 and one or more server 120, the system 100 can determine a relevant road condition 130 according to information communicated to the vehicle 101 from the server 120. In embodiments, the road condition 130 may be a communicated vehicle accident record corresponding to one or more vehicle accident locations to indicate the relative safety of a current or upcoming route. In embodiments, the one or more vehicle accident locations may be determined from a database of police reports, insurance claims, aggregated commercial accident reports or the like. The database or databases may, for instance, contain vehicle collision information corresponding to a spatial area along an upcoming route, including a number of collisions along the route, the position of the collisions, and the overall frequency of collisions in the area. Additionally, the road condition 130 may be a communicated level of traffic in front of the vehicle 101. In embodiments, the road condition 130 may be communicated road information corresponding to the location of pedestrian areas, cross walks, or other points of interest like schools, hospitals, or the like. In embodiments, the road condition 130 may further include communicated weather information like the sunlight conditions or precipitation along a current or future route of the vehicle 101. Each relevant road condition 130 communicated by the server 120 may be assigned corresponding positional information corresponding to its location relative to the vehicle 101. The processor 106 may thereby compare the spatial positon of the vehicle 101, determined by the GPS unit 102, to the position of the road condition 130 to evaluate the risk probability to the vehicle 101.

The processor 106 may be configured to compare the position of the vehicle 101 against the position and nature of the road condition 130 to determine a risk probability corresponding to the position of the vehicle 101. The processor 106 may receive positional information pertaining to the vehicle 101 from the GPS unit 102 and the processor 106 may receive environmental data or vehicle steering data from one or more vehicle input devices 108 to determine a road condition 130. Additionally, the processor 106 may receive information corresponding to the road condition 130 from the server 120. It should be understood, that the position of the vehicle 101, as used herein, can refer to either the current position or a predicted future position of the vehicle 101. The risk probability may be determined according to any relevant metric known to those of ordinary skill. In embodiments, the risk probability to the vehicle 101 may be determined, at least in part, by comparing the position of the vehicle 101 to the positon of the road condition 130 determined by the processor 106 and/or communicated to the processor 106 via the server 120. The processor 106 may calculate, based on the proximity of the vehicle 101 and the road condition 130 and other relevant environmental and vehicle steering data, a likelihood of a collision between the vehicle 101 and the road condition 130. In one embodiment, the processor 106 may determine the risk probability by determining if the position of the vehicle 101 is within or entering a geographic area in which the vehicle input devices 108 have detected a high traffic level or in which a historical database communicated to the vehicle 101 indicates a high traffic level is common. In another embodiment, the processor 106 may determine the risk probability by determining if the position of the vehicle 101 is within or entering a geographic area in which a historical database is communicated to the vehicle 101 from the server 120, indicating that a roadway or intersection has an elevated rate of collisions relative to an average accident rate for the region. In embodiments, determining the risk probability may include determining if the vehicle 101 is currently positioned within or entering a geographic area corresponding to at least one historic vehicle accident location and elevating the risk probability accordingly. One or more vehicle accident locations may be determined by communicating a database of vehicle accident information to the processor 106 in advance through the programming of the vehicle 101 or in real-time via the server 120.

In embodiments, the processor 106 may execute one or more programs to evaluate the road condition 130 using a computational model, such as a deep learning model, a predictive model, or the like, pattern matching, or any similar computational method. Furthermore, in embodiments, the risk probability to the vehicle 101 may be determined, at least in part, by evaluating historical databases and pre-determined risk values associated with various detected or communicated road conditions 130. For instance, in one example, the processor 106 may assign a pre-determined maximum risk value when the vehicle 101 is passing through an area designated as a school crosswalk. In another example, the risk probability corresponding to a moderate-level of detected traffic from the vehicle input devices 108 may be elevated due to the detection of an environmental condition with a heightened pre-determined risk value, like rain or snow that may inhibit the vehicle's ability to brake.

The processor 106 may determine the risk probability based on a calculated likelihood of a collision expressed as a percentage and determined by the models discussed hereinabove. In non-limiting embodiments, the risk probability may be compared against one or more threshold risk probability values to enable the processor 106 to classify the current risk to the vehicle 101 and adjust a data collection parameter 110 or a data retention parameter 114 accordingly. In an illustrative embodiment, the system 100 may include a single programmed threshold risk probability value, whereby the processor 106 may adjust the data collection parameter 110 and/or the data retention parameter 114 when the calculated risk probability is above the threshold value. In another illustrative embodiment, the system 100 may include a series of threshold risk probability values. For instance, the series may include any number of programmed threshold risk probability values, wherein each successive threshold risk probability value is greater than the previous threshold risk probability value. In such embodiments, the processor 106 may iteratively adjust the data collection parameter 110 and/or the data retention parameter 114 when the calculated risk probability is determined to exceed each threshold risk probability value within the series.

The processor 106 may be configured to adjust the data collection parameter 110 of the one or more vehicle input devices 108 according to the comparison of the calculated risk probability versus the one or more programmed threshold risk probability values. The data collection parameter 110 corresponds to the amount of data being collected by the one or more vehicle input devices 108 at a given time. By adjusting the data collection parameter 110, the vehicle event information collection system 100 can prioritize collecting more data at locations where the vehicle 101 is more likely to be engaged in a collision. Likewise, the vehicle event information collection system 100 can collect less data at locations where the vehicle 101 is less likely to be engaged in a collision. In so doing, the vehicle event information collection system 100 can maximize efficiency by conserving processing power and storage when the risk probability is low. Additionally, the vehicle event information collection system 100 can maximize data collection by increasing the amount and the resolution of captured data when the risk probability of a collision is high. Accordingly, the captured data inputs from the one or more vehicle input devices 108 are communicated to the processor 106 and/or the memory module 112 according to the data collection parameter 110 and the data retention parameter 114 to maximize the efficiency of the system 100.

In embodiments, adjusting the data collection parameter 110 includes selectively engaging a smaller portion of the vehicle input devices 108 when the risk probability is below a threshold risk probability value and selectively engaging a larger portion or all of the vehicle input devices 108 when the risk probability is above a threshold risk probability value. It should be understood, that in some embodiments portions of the vehicle input devices 108 may be selectively engaged as groups according to the calculated risk probability. In other embodiments, individual vehicle input devices 108 may be individually engaged by the processor 106 in a priority order corresponding to the calculated risk probability and the position of the vehicle input device 108 relative to the road condition 130. In embodiments, the processor 106 may adjust the data collection parameter 110 to selectively adjust the frequency at which at least one of the one or more vehicle input devices 108 captures data. For instance, the data may be collected by the vehicle input devices 108 at a higher frequency when the calculated risk probability is above a threshold risk probability value and the data input may be collected by the vehicle input devices 108 at a lower frequency when the calculated risk probability is below a threshold risk probability value. In other embodiments, the processor 106 may adjust the data collection parameter 110 to incrementally increase the frequency of data collection in proportion to an increase or a decrease of the calculated risk probability. In embodiments, the processor 106 may adjust the data collection parameter 110 by selectively adjusting the resolution at which at least one of the one or more vehicle input devices 108 captures the data input. For instance, the data input may be collected by the vehicle input devices 108 at a higher resolution when the calculated risk probability is above a threshold risk probability value and the data input may be collected by the vehicle input devices 108 at a lower resolution when the calculated risk probability is below a threshold risk probability value. In embodiments, the vehicle input devices 108 may incrementally increase the resolution at which input data is collected in proportion to an increase or a decrease in the calculated risk probability. In further embodiments, the processor 106 may adjust the data collection parameter 110 by selectively adjusting a signal strength and or data collection range of a LIDAR or RADAR sensor corresponding to the calculated risk probability in a similar manner as discussed hereinabove.

Furthermore, the processor 106 may be configured to optimize a data retention parameter 114 of the memory module 112 according to the calculated risk probability. The data retention parameter 114 corresponds to the amount and/or resolution of data being stored by the memory module 112 at a given time. By adjusting the data retention parameter 114, the vehicle event information collection system 100 can prioritize saving and processing more data at locations where the vehicle 101 is more likely to be engaged in a collision. Likewise, the vehicle event information collection system 100 can save and process less data at locations where the vehicle 101 is less likely to be engaged in a collision. In so doing, the vehicle event information collection system 100 can maximize efficiency by reserving processing power and storage when the risk probability to the vehicle 101 is low.

The processor 106 may adjust a data retention parameter 114 according to the risk probability and communicate the data input from at least one vehicle input device 108 to the memory module 112 to be stored according to the data retention parameter 114. In embodiments, the processor 106 may adjust the data retention parameter 114 by selectively storing the data input from the vehicle input devices 108 at a lower resolution when the risk probability is below a threshold value and selectively storing the data input at a higher resolution when the risk probability is calculated to be greater than a threshold value. In embodiments, adjusting the data retention parameter 114 may comprise incrementally increasing the resolution at which input data is saved to the memory module 112 in proportion to an increase or a decrease in the calculated risk probability.

In embodiments, the processor 106 may communicate the data input from at least one vehicle input device 108 to the memory module 112 to be stored for a pre-determined buffer period prior and then the processor 106 may subsequently delete the data if no collision is determined to have occurred. In so doing, the processor 106 can ensure increased performance and reduce the collection of inconsequential data. The buffer period represents an amount of time the data input is stored before being deleted. In embodiments, adjusting the data collection parameter 110 includes increasing or decreasing the buffer period using the processor 106 according to the calculated risk probability. In embodiments, the processor 106 may store the data input for less than or equal to sixty seconds when the risk probability is calculated to be below a threshold risk probability value. In other embodiments, the processor 106 may adjust the buffer period to retain the data input for greater than or equal to two minutes when the risk probability is calculated to be above a threshold risk probability value. In embodiments, the buffer period may be adjusted to increase proportionally with the calculated risk probability to the vehicle 101. It should be understood that the buffer period is not limited to any specific quantity of time discussed herein.

Referring now to FIG. 3, depicted is an illustrative example of the vehicle event information collection system 100 operating as the vehicle 101 approaches an intersection with a high level of traffic. As the vehicle 101 is operating, the GPS unit 102 is in communication with the processor 106 to enable the processor 106 to determine the current and future spatial position of the vehicle 101. Along an open road, the one or more vehicle input devices 108 capture and transmit environmental data and vehicle steering data pertaining to the surroundings of the vehicle 101 to the processor 106 at a baseline resolution and frequency to enable the processor 106 to evaluate the road condition 130. However, as the vehicle 101 approaches the intersection, the processor 106 may determine a change in the road condition 130 based on the captured environmental data and vehicle steering data from the vehicle input devices 108, indicating the presence of multiple vehicles. Accordingly, the processor 106 may compare the current and future spatial position of the vehicle 101 to the positon and characteristics of the determined road condition 130 to calculate a change in the risk probability to the vehicle 101. In this example, due to the presence of vehicles in the intersection and the speed at which the vehicle 101 is approaching the road condition 130, the processor 106 has determined that the risk probability to the vehicle 101 exceeds a programmed threshold value. Accordingly, the processor 106 has adjusted the data collection parameter 110 to engage all of the vehicle input devices 108 on the front of the vehicle 101, increase the frequency at which each vehicle input device 108 is capturing data, and increase the resolution at which each vehicle input device 108 is capturing data. Additionally, the processor 106 has adjusted the data retention parameter 114 to save captured data to the memory module 112 at a higher resolution and to increase the length buffer window to retain captured data for a relatively longer period of time before deleting the captured data.

Referring now to FIG. 4, depicted is an illustrative example of the vehicle event information collection system 100 operating as the vehicle 101 approaches an intersection with a relatively high historic rate of vehicle accidents. As the vehicle 101 is operating, the GPS unit 102 is in communication with the processor 106 to enable the processor 106 to determine the current and future spatial position of the vehicle 101. Along an open road, the one or more vehicle input devices 108 capture and transmit environmental data and vehicle steering data pertaining to the surroundings of the vehicle 101 to the processor 106 at a baseline resolution and frequency to enable the processor 106 to evaluate the road condition 130. Additionally, the vehicle 101 includes a communication device 104 in communication with an external server 120 to receive information pertaining to the upcoming road condition 130. As the vehicle 101 approaches the intersection, the processor 106 may determine a change in the road condition 130 based on direct measurements from the vehicle input devices 108 in combination with wirelessly communicated data from the server 120. In this instance, the server 120 has communicated information from a database of vehicle accident information to the vehicle 101 enabling the processor 106 to determine that the upcoming intersection has high historic rate of vehicle accidents. Accordingly, the processor 106 may compare the current and future spatial position of the vehicle 101 to the positon and characteristics of the determined road condition 130 to calculate a change in the risk probability to the vehicle 101. In this example, the processor 106 has evaluated the road condition 130, factoring in the high historic rate of accidents and the captured input data from the vehicle input devices 108, and determined that the risk probability to the vehicle 101 exceeds a programmed threshold value. Accordingly, the processor 106 has adjusted the data collection parameter 110 to engage all of the vehicle input devices 108 on the front of the vehicle 101, increased the frequency at which each vehicle input device 108 is capturing data, and increased the resolution at which each vehicle input device 108 is capturing data. Additionally, the processor 106 has adjusted the data retention parameter 114 to save captured data to the memory module 112 at a higher resolution and to increase the length buffer window to retain captured data for a relatively longer period of time before deleting the captured data.

FIG. 5 depicts a flow diagram of an example method 200 performed by the processor 106. FIG. 5 may reference and incorporate any of the above constituent components and corresponding disclosure explained above with respect to FIGS. 1-4, such as the example vehicle event information collection system 100.

At block 202, the processor 106 may be configured to determine a spatial position of a vehicle using one or more processors based on a signal of a GPS unit of the vehicle.

At block 204, the processor 106 may be configured to determine a road condition corresponding to the spatial position of the vehicle. In embodiments, the road condition may be communicated to the processor 106 and may include a level of traffic or a vehicle accident record corresponding to at least one vehicle event location. In embodiments, the road condition is directly measured by one or more of the vehicle input devices 108.

At block 206, based on the comparison, the processor 106 is configured to determine a risk probability corresponding to a spatial position of the vehicle by comparing the spatial position of the vehicle against the road condition.

At block 208, the processor 106 is configured to adjust a data collection parameter of one or more vehicle input devices 108 according to the determined risk probability. In embodiments, adjusting the data collection parameter may include selectively engaging a smaller portion of the vehicle input devices 108 when the risk probability is below a threshold vale and selectively engaging a larger portion or all of the vehicle input devices 108 when the risk probability is above a threshold value. In embodiments, adjusting the data collection parameter may also include selectively increasing the frequency at which at least one of the one or more vehicle input devices 108 captures the environmental data and the vehicle steering data when the risk probability is above a threshold value. In embodiments, adjusting the data collection parameter may also include selectively increasing the resolution at which at least one of the one or more vehicle input devices 108 captures the environmental data and the vehicle steering data when the risk probability is above a threshold value.

At block 210, in embodiments, the processor 106 is configured to adjust a data retention parameter according to the determined risk probability. In embodiments, adjusting the data retention parameter may include selectively storing the data input at a higher resolution when the risk probability is above a threshold risk probability value and selectively storing the data input at a lower resolution when the risk probability is below a threshold risk probability value. Additionally, adjusting the data retention parameter may also include selectively increasing a buffer period to increase an amount of time the data input is retained before being deleted when the risk probability is above a threshold risk probability value

The systems and methods disclosed herein improve the collection and retention of vehicle event information corresponding to a potential risk to the vehicle. Many traditional and autonomous vehicles constantly collect, processes, and store data via one or more input devices irrespective of the relevance of the collected data. Untargeted data collection can lead to decreased performance of the vehicle's processor and limited storage due to data aggregation. It is beneficial to identify specific scenarios and locations at which data collection and retention would be more relevant to minimize the burden placed on the processor. By providing systems and methods that can determine the risk probability and optimize a vehicle's data collection and retention procedures accordingly, the performance of the vehicle's processing unit can be improved while maintaining adequate data collection at all relevant periods.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some aspects may be combined in some other aspects. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for collecting vehicle event information comprising:
one or more vehicle input devices operable to capture environmental data and vehicle steering data;
one or more processors operable to:
determine a spatial position of the vehicle based on a signal of a GPS unit of the vehicle;
determine a road condition corresponding to the spatial position of the vehicle;
compare the spatial position of the vehicle against the road condition to determine a risk probability corresponding to the spatial position of the vehicle; and
adjust a data collection parameter of at least one of the one or more vehicle input devices according to the risk probability.

2. The system for collecting vehicle event information of claim 1, further comprising one or more communication devices operable to transmit and receive data corresponding to the road condition.

3. The system for collecting vehicle event information of claim 2, wherein the one or more communication devices communicate with an external server to receive data corresponding to the road condition.

4. The system for collecting vehicle event information of claim 1, wherein the road condition is directly measured by one or more of the vehicle input devices.

5. The system for collecting vehicle event information of claim 1, wherein at least one of the one or more vehicle input devices comprises a camera positioned on an exterior of the vehicle.

6. The system for collecting vehicle event information of claim 1, wherein at least one of the one or more vehicle input devices comprises a LIDAR sensor positioned on an exterior of the vehicle.

7. The system for collecting vehicle event information of claim 1, wherein adjusting the data collection parameter further comprises selectively engaging a portion of the vehicle input devices when the risk probability is below a first threshold value and selectively engaging all of the vehicle input devices when the risk probability is above a second threshold value.

8. The system for collecting vehicle event information of claim 1, wherein adjusting the data collection parameter further comprises selectively increasing a frequency at which at least one of the one or more vehicle input devices captures the environmental data and the vehicle steering data when the risk probability is above a threshold value.

9. The system for collecting vehicle event information of claim 1, wherein adjusting the data collection parameter further comprises selectively increasing a resolution at which at least one of the one or more vehicle input devices captures the environmental data and the vehicle steering data when the risk probability is above a threshold value.

10. The system for collecting vehicle event information of claim 6, wherein optimizing the data collection parameter further comprises selectively increasing a data collection range of the LIDAR sensor when the risk probability is above a threshold value.

11. The system for collecting vehicle event information of claim 1, further comprising a memory module to store the environmental data and the vehicle steering data.

12. A method for collecting vehicle event information, the method comprising:
determining a spatial position of a vehicle using one or more processors based on a signal of a GPS unit of the vehicle;
determining a road condition corresponding to the spatial position of the vehicle;
determining a risk probability corresponding to the spatial position of the vehicle by comparing the spatial position of the vehicle against the road condition; and
adjusting a data collection parameter of one or more vehicle input devices according to the determined risk probability to selectively capture environmental data and vehicle steering data.

13. The method of claim 12, further comprising adjusting a data retention parameter according to the determined risk probability to selectively store the captured environmental data and the vehicle steering data to a memory module.

14. The method of claim 12, wherein the road condition is a level of traffic or a vehicle accident record corresponding to at least one vehicle event location.

15. The method of claim 12, wherein the road condition is directly measured by one or more of the vehicle input devices.

16. The method of claim 12, wherein adjusting the data collection parameter further comprises selectively engaging a portion of the vehicle input devices when the risk probability is below a first threshold vale and selectively engaging all of the vehicle input devices when the risk probability is above a second threshold value.

17. The method of claim 12, wherein adjusting the data collection parameter further comprises selectively increasing a frequency at which at least one of the one or more vehicle input devices captures the environmental data and the vehicle steering data when the risk probability is above a threshold value.

18. The method of claim 12, wherein adjusting the data collection parameter further comprises selectively increasing a resolution at which at least one of the one or more vehicle input devices captures the environmental data and the vehicle steering data when the risk probability is above a threshold value.

19. The method of claim 13, wherein adjusting the data retention parameter further comprises selectively storing the data input at a higher resolution when the risk probability is above a threshold risk probability value.

20. The method of claim 13, wherein adjusting the data retention parameter further comprises selectively increasing a buffer period to increase an amount of time the data input is stored before being deleted when the risk probability is above a threshold risk probability value.
